(19) United States
(12) Patent Application Publication
(10) Pub. No.: US 2014/0101137 A1
(43) Pub. Date: Apr. 10, 2014

(54) SYSTEM AND METHOD FOR A CONTACT PERSONA-BASED GROUP IN A SOCIAL MEDIA NETWORK

(71) Applicant: salesforce.com, inc., San Francisco, CA (US)

(72) Inventor: Rajaram Satyanarayanan, San Jose, CA (US)

(73) Assignee: salesforce.com, inc., San Francisco, CA (US)

(21) Appl. No.: 14/041,388

(22) Filed: Sep. 30, 2013

Related U.S. Application Data
(60) Provisional application No. 61/711,967, filed on Oct. 10, 2012.

(51) Int. Cl. H04L 29/08

(52) U.S. Cl. CPC H04L 67/306
USPC 707/722

(57) ABSTRACT

A system and method for automatically adding users to a dynamically created virtual group for a social network. The virtual group is created on the basis of a user's current interest in topics or entities as indicated in the user's personal profile. The user's current interests can also be inferred from the user's interaction with the social network.

### PRIORITY AND RELATED APPLICATION DATA

This application claims priority from U.S. Patent Application No. 61/711,967, filed Oct. 10, 2012, entitled System and Method for Contact-Persona Based Social Chatter Group; and is related to: U.S. Pat. No. 8,498,994 entitled Social Files; and U.S. patent application Ser. No. 13/767,666, filed Feb. 14, 2013, entitled Computer Implemented Methods and Apparatus for Automatically Following Entities in an Online Social Network; each of which is hereby incorporated by reference in its entirety.

### COPYRIGHT NOTICE

A portion of this disclosure contains material which is subject to copyright protection. The copyright owner has no objection to the facsimile reproduction by anyone of this patent disclosure, as it appears in the public records of the U.S. Patent & Trademark Office, but otherwise reserves all copyright rights whatsoever.

### TECHNICAL FIELD

This disclosure relates generally to providing on-demand services in an online social network using a database system and, more specifically, to techniques for dynamically forming virtual groups of users in the online social network based on the users' interest in topics or entities.

### BACKGROUND

“Cloud computing” services provide shared resources, software and information to computers and other digital devices upon request. In cloud computing environments, software can be accessible over the Internet rather than installed locally on in-house computer systems. This allows resources to be dynamically scalable and in many cases virtualized. Thus, end users no longer have any need for expertise or control over the technology infrastructure “in the cloud” that supports them.

Database resources can be provided in a cloud computing context. However, using conventional database management techniques, it is difficult for one user to know about the activity of other users of a database system in the cloud or another network, particularly when such activity may be relevant or of general interest to the one user. Further, it is often difficult or at least burdensome to identify other users or groups who might have current relevant information for the one user. However, the explosion of social networking has provided tools that are used to facilitate improved communication among users and groups of users, particularly in an enterprise environment with access to database resources. For example, users or groups of social networking applications may subscribe to information feeds, or may follow data records, or may follow entities such as other users or groups of users. However, the burden remains upon users to locate and subscribe to relevant information feeds or to select appropriate entities to follow. Thus, it would be desirable to provide a simplified process for automatically collecting relevant information to present to users, rather than having users search for and set up the collection of relevant information on their own.

### BRIEF DESCRIPTION OF THE DRAWINGS

The included drawings are for illustrative purposes and serve only to provide examples of possible structures and operations for the disclosed inventive systems, apparatus, and methods for automatically following entities in an online social network. These drawings in no way limit any changes in form and detail that may be made by one skilled in the art without departing from the spirit and scope of the disclosed implementations.

FIG. 1 is a block diagram of one embodiment of a computing environment in which a multi-tenant on-demand database service operates.

FIG. 2 is a block diagram of a more detailed embodiment showing some implementations of elements of the computing environment of FIG. 1 and various possible interconnections between these elements.

FIG. 3A is a block diagram illustrating a schema and corresponding examples of contact data records.

FIG. 3B is a block diagram illustrating an alternative schema for contact data records.

FIG. 3C is a block diagram illustrating a schema for a personal profile data record.

FIG. 4 is a flow chart illustrating a process for creating and adding users to a virtual group.

FIG. 5 is block diagram of one embodiment of a system for rendering a user interface.

FIG. 6 is a flow chart illustrating a process for rendering content to the user interface for a virtual group.

FIG. 7 is block diagram of an alternative embodiment of a system for rendering a user interface with two-way collaboration and incorporation of evolving technologies.

FIG. 8 is a flow chart illustrating a process for user interaction in a collaborative space of a virtual group

FIG. 9 is block diagram of an alternative embodiment of a system for rendering a user interface in a collaborative recommendation environment.

### DETAILED DESCRIPTION

This disclosure describes systems and methods for dynamically and automatically creating “virtual” groups in an online social network. The creation of a virtual group is not carried out by a user, but instead, by the social network itself based upon the personal interests of users in various topics or entities. Users' contact records are stored in a contact database that is accessible to the social network, and a user's personal interests can be added or linked to the contact records, for example, as a user profile. In one embodiment, a user creates and updates their own profile manually as they see fit to include personal and (presumably) current interests. In another embodiment, the social network infers the current interests of users by monitoring user profiles.

A user's persona can be stored with user contact records in a contact database. As with user-created groups, a virtual group can subscribe to feeds or follow other users or entities.

In the following detailed description, reference is made to the accompanying drawings, which form a part of the description and in which are shown, by way of illustration, specific example implementations. Although these implementations are described in sufficient detail to enable one skilled in the art to practice the disclosed implementations, it is understood that these examples are not limiting, and that other implementations may be used and changes may be made to the descriptions here without departing from their spirit and scope. For example, the methods and processes shown and described herein are not necessarily performed in the order indicated. It should also be understood that the methods and processes may include more or fewer blocks or steps than are indicated. In some implementations, blocks described herein as separate blocks may be combined. Conversely, what may be described herein as a single block may be implemented in multiple blocks.

The implementations described herein may be embodied in various types of hardware, software, firmware, and combinations thereof. For example, some techniques disclosed herein may be implemented, at least in part, by computer-readable media that include program instructions, state information, etc., for performing various services and operations described. Examples of program instructions include machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

### 1. OVERVIEW OF SOCIAL NETWORKS

The various implementations described herein are directed to different methods, apparatus, systems, and computer-readable storage media for dynamically and automatically creating groups in an online social network based on the persona or personal interests of users as stored with user contact records in a contact database. One example of an online social network is the Chatter® social network, provided by salesforce.com, inc. of San Francisco, Calif. Online social networks are increasingly becoming a common way to facilitate communication among people and groups of people, any of whom can be recognized as users of a social networking system. Online social networks can be implemented in various settings, including organizations, e.g., enterprises such as companies or business partnerships, academic institutions, or sub-groups within such an organization. For instance, the Chatter® social network is used by employees in a business organization to share data, communicate, and collaborate with each other for various purposes.

In some online social networks, users can access one or more “information feeds,” which include information updates presented as items or entries in the feed. Such a feed item can include a single information update or a collection of individual information updates. A feed item can include various types of data including character-based data, audio data, image data and/or video data. An information feed can be displayed in a graphical user interface (GUI) on a display device such as the display of a computing device as described below. The information updates can include social network data from various sources and can be stored in an on-demand database. In some implementations, the disclosed methods, apparatus, systems, and computer-readable storage media may be configured or designed for use in a multi-tenant database environment.

In some implementations, an online social network may allow a user to “follow” data objects in the form of records such as cases, accounts, or opportunities, in addition to following individual users and groups of users. The action of following a record stored in a database, as described in greater detail below, allows a user to track the progress of that record. Updates or changes to the record are one type of information update that can occur and be noted on an information feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate authorizations are a prerequisite to a user following the record.

Information updates can include updates which may or may not be linked with a particular record. For example, information updates can be user-submitted messages or can otherwise be generated in response to user actions or in response to events. Examples of messages include posts, comments, indications of a user's personal preferences such as “likes” and “dislikes”, updates to a user's status, uploaded files, and hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, about, or otherwise associated with another user. For instance, a first user may be able to see information posted by a second user to the second user's personal page on the social network. One implementation a personal page is a user's profile page, for example, in the form of a web page representing the user's profile. In one example, when the first user is following the second user, the first user's news feed can receive a post from the second user submitted to the second user's profile feed, also referred to herein as the user's “wall,” which is one example of an information feed displayed on the user's profile page.

In some implementations, an information feed may be specific to a group of users of an online social network. For instance, a group of users may publish a news feed. Members of the group may view and post to the group feed in accordance with a permissions configuration for the news feed and the group. Information updates in a group context can also include changes to group status information. In some implementations, when data such as posts or comments input from one or more users are submitted to an information feed for a particular user, group, object, or other entity within an online social network, an e-mail notification or other type of network communication may be transmitted to all users following the user, group, or object in addition to the inclusion of the data as a feed item in one or more information feeds, such as a user's profile feed, a news feed, or a record feed. In some online social networks, the occurrence of such a notification is limited to the first instance of a published input, which may form part of a larger conversation. For instance, a notification may be transmitted for an initial post, but not for comments on the post. In some other implementations, a separate notification is transmitted for each such information update.

In some implementations, for example, as described in U.S. patent application Ser. No. 13/767,666, filed Feb. 14, 2013, entitled Computer Implemented Methods and Apparatus for Automatically Following Entities in an Online Social Network; which is incorporated by reference in its entirety, the social network can be configured so that an entity can automatically follow other entities. For example, users can be auto-subscribed and auto-unsubscribed from feeds of relevant entities according to the users' geographical location and/or other criteria.

A typical user does not know the names of the entities he wishes to follow. Instead, the user generally knows of the topics that are of interest to him. Thus, in one scenario, a user of a social network can perform a keyword search for topics or entities of interest. However, the results of a search query may include, in some instances, hundreds and even thousands of users, which a user can then research and choose to follow. That is, the results may include a list of irrelevant and relevant entities, and the onus is on the user to scroll through the list of entities, mentally filter relevant entities, and then elect to follow the filtered entities. These tasks can be cumbersome, mentally taxing and time consuming for the user.

In another scenario, a user can indicate personal topics of interest, or of entities followed, on a social network profile page, or by posts or comments on the social network. As described in this disclosure, a users' interests or follows can provide a basis for automatically forming a virtual group of users that have the same interests or follow the same entities.

In some implementations, profile information associated with the first and/or second entities can be analyzed to determine whether the automatic follow rule is to be applied. For example, a group may automatically be formed on the basis of common hobbies, interests, group memberships, titles and positions in an organizational hierarchy, education, language, religious information, political views, areas of expertise and/or preference information. For example, if the user's profile information indicates that he is a wine enthusiast, then the user may be automatically subscribed to a group for wine enthusiasts. Further, the group for wine enthusiasts can be automatically subscribed to receive feed items including coupons, advertisements and other marketing information relevant to the group interest.

A shortcoming of conventional online social networks is that the burden is on the user to stop following other entities. However, as disclosed herein, virtual groups that are created automatically may be given a limited duration for users, and the duration may be configured.

### 2. DEFINITIONS

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “information feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different information feeds. A second user following a first user and a record can receive the feed items associated with the first user and the record for display in the second user's news feed, which is another type of information feed. In some implementations, the feed items from any number of followed users and records can be combined into a single information feed of a particular user.

As examples, a feed item can be a message, such as a user-generated post of text data, and a feed tracked update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a graphical user interface (GUI), for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Messages and feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and messages, such as posts, comments, likes, etc., can define group conversations and change over time.

An “entity feed” or “record feed” generally refers to a feed of feed items about a particular record in the database, such as feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” is a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

### 3. OVERVIEW OF DATABASE SYSTEM AND SERVICES

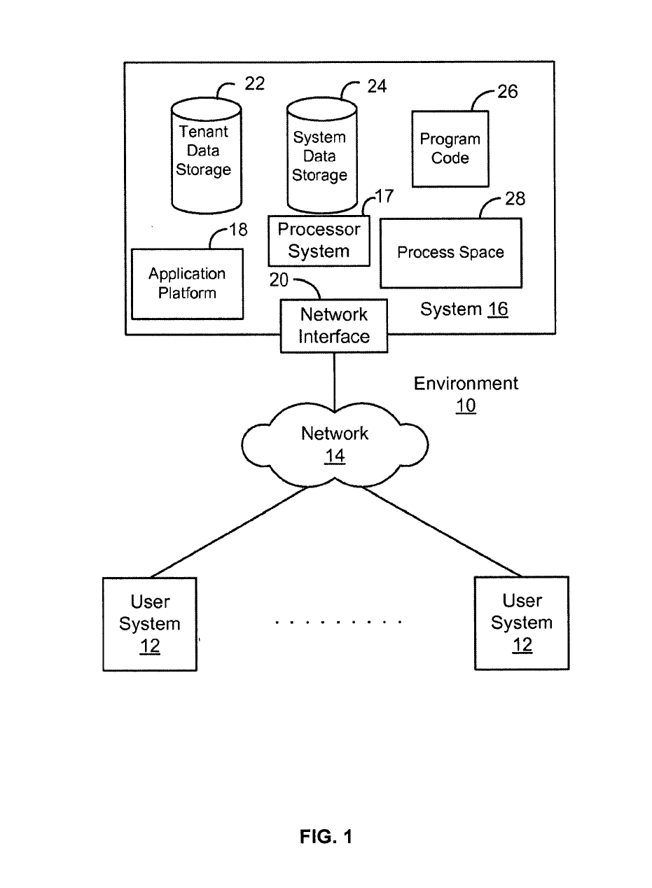

FIG. 1 shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

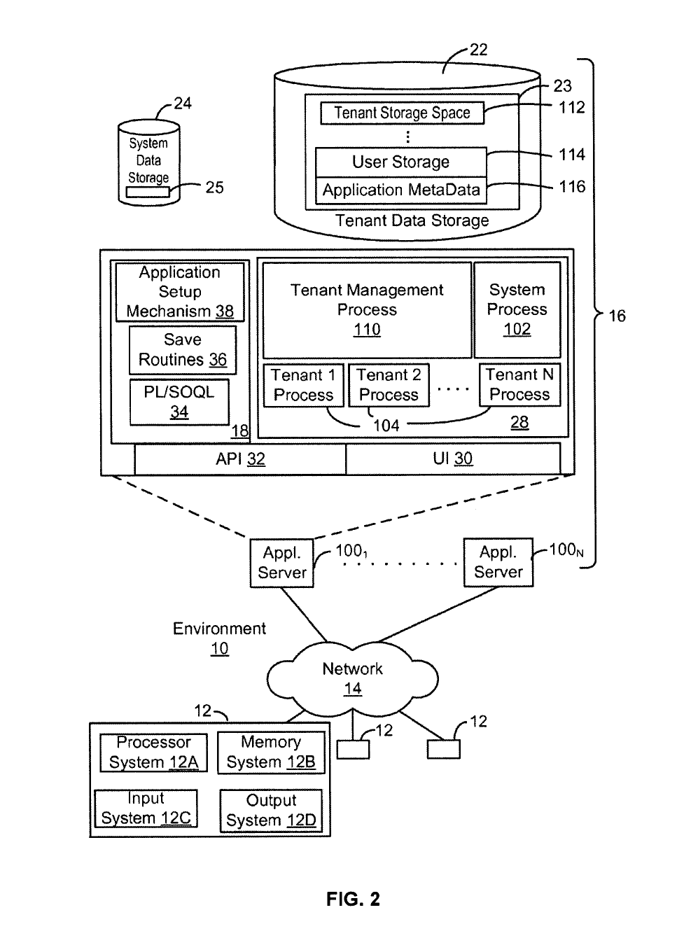

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 1 (and in more detail in FIG. 2) user systems 12 might interact via a network 14 with an on-demand database service, which is implemented in the example of FIG. 1 as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 1, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 1A and 1B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 2 shows a block diagram of an example of some implementations of elements of FIG. 1 and various possible interconnections between these elements. That is, FIG. 2 also illustrates environment 10. However, in FIG. 2 elements of system 16 and various interconnections in some implementations are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 1001-100N, system process space 102, tenant process spaces 104, tenant management process space 110, tenant storage space 112, user storage 114, and application metadata 116. In other implementations, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to communicate with tenant data storage 22 and the tenant data 23 therein, and system data storage 24 and the system data 25 therein to serve requests of user systems 12. The tenant data 23 might be divided into individual tenant storage spaces 112, which can be either a physical arrangement and/or a logical arrangement of data. Within each tenant storage space 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage space 112. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language implementations is discussed in U.S. Pat. No. 7,730,478, entitled Method And System For Allowing Access To Developed Applications Via A Multi-Tenant On-Demand Database Service, which is incorporated by reference in its entirety. Invocations to applications may be detected by one or more system processes, which manage retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 1001 might be coupled via the network 14 (e.g., the Internet), another application server 100N-1 might be coupled via a direct network link, and another application server 100N might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain implementations, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one implementation, therefore, an interface system implementing a load balancing function (e.g., an F5 Big-IP load balancer) is communicably coupled between the application servers 100 and the user systems 12 to distribute requests to the application servers 100. In one implementation, the load balancer uses a least connections algorithm to route user requests to the application servers 100. Other examples of load balancing algorithms, such as round robin and observed response time, also can be used. For example, in certain implementations, three consecutive requests from the same user could hit three different application servers 100, and three requests from different users could hit the same application server 100. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 100 to request and update system-level and tenant-level data from system 16 that may involve sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, a set of standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table.”

More specifically, a multi-tenant database 16 can provide its users with access to large numbers of contacts, typically by subscription. For example, the data.com Contacts by Jigsaw® database provided by data.com now has records for over 30 million business contacts. These contact records can be augmented with other attributes and interests, for example, using data mining technologies on the social network. Further, as described more fully herein, qualitative attributes can be gathered from these records to dynamically and automatically form informal “virtual” groups within the social network framework.

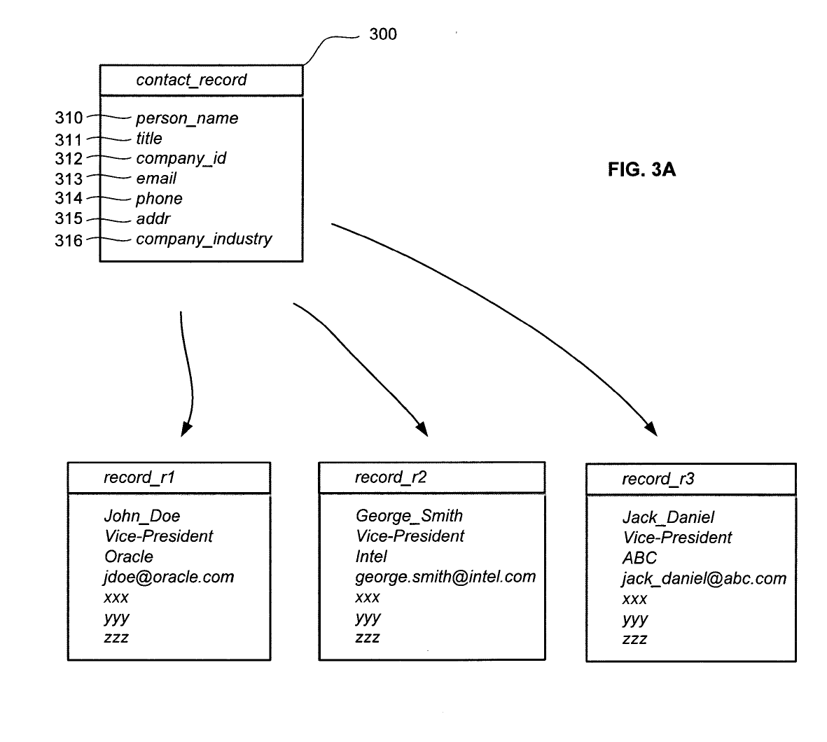

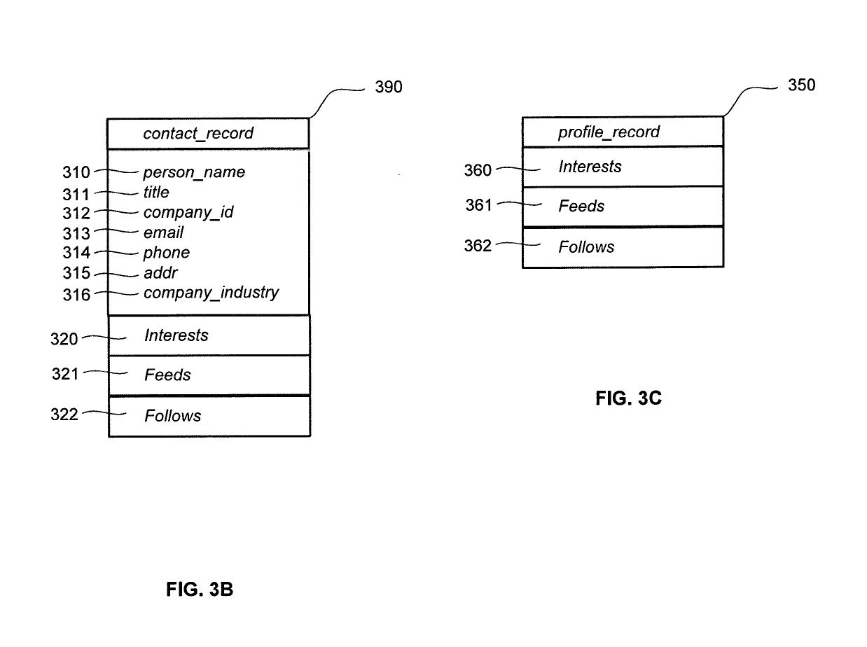

Referring now to FIG. 3A, a schema 300 for a database record called contact record is illustrated. Individual data records are created and stored according to the schema 300, such as record_r1 301, record_r2 302, and record_r3 303. In this example, each record represents a business card or contact for a single individual. A number of fields define the schema 300. In this example, fields 310-316 are illustrated, but of course more or fewer fields may be defined. Field 310 (person_name) is for the person's name and typically has at least two sub-field objects, namely first_name and last_name, although other field variations are common, as further described below, including Hast (i.e., first initial plus last_name, which is commonly used in email addressing schemas). Field 311 (title) represents the title or position of the individual. Field 312 (company_id) represents the company that employs the individual. Field 313 (email) represents the email address for the individual. Field 314 (phone) represents the phone number for the individual. Field 315 (address) contains the company address for the individual. Field 316 (company_industries) contains a description of the industry characterization for the company. The fields described are merely illustrative and could include many other fields or alternative fields.

For example, the schema 300 may be modified as schema 390 shown in FIG. 3B to have supplemental field(s) 320, 321 and 322 for including various personal interests and/or attributes of the contact, i.e., a personal profile. Alternatively, a schema 350 for another database record called profile_record is illustrated in FIG. 3C, and fields 360-362 are illustrated as defining this schema. Of course, more or fewer fields may be defined for either schema.

Field 320 in schema 300 and field 360 in schema 350 are for personal interests of the user, and may be configured to include text, media, links or other information. Field 321 in schema 300 and field 361 in schema 350 may be configured to include links or descriptions of information feeds for the user. Field 322 in schema 300 and field 362 in schema 350 may be configured to include links or descriptions of the objects or entities in the social network that the user is following. Database 16 may be configured to store and access contacts such as records r1, r2, etc.

### 4. AUTOMATIC GROUP CREATION

As described above, contact records in a database can be augmented with other attributes and interests, either from direct entry by the user, or alternatively, by using data mining technologies on the social network. These other attributes and interests can be added directly to a user's contact record, or included in another data record that is linked to the user's contact record. By gathering qualitative attributes, informal groups can be formed using the social network framework.

In one implementation, virtual groups are formed based on the current interest of users in specific topics or entities. The current interest in topics or entities for a user can be inferred based on the persona of the user as reflected in the user's profile in the contact database. Further, virtual groups can be configured have feeds from one or more groups or external social networks such as LinkedIn or Facebook. Virtual groups can allow end users to view all related content and feed in system-guided manner.

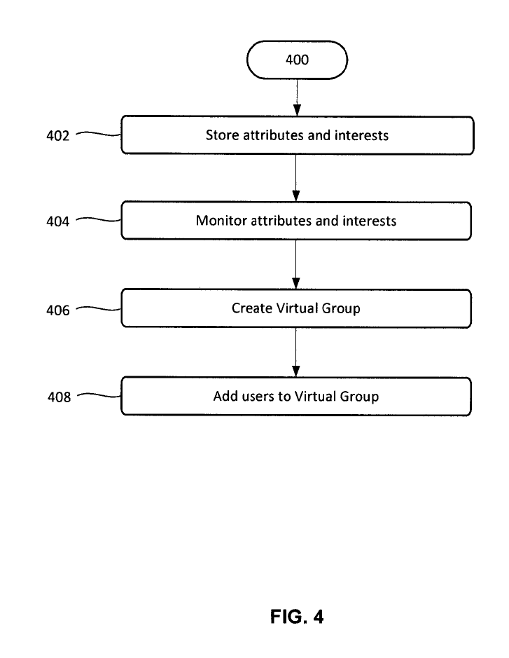

Referring now to FIG. 4, a process 400 is illustrated for automatically and dynamically creating a virtual group from a contact-based persona, e.g., the users personal interest in topics or entities. Process 400 (and other methods described herein) may be implemented at least in part in the multi-tenant database system 16.

In step 402, attributes and interests of a user are stored with the user's contact record in a contact database. The attributes and interests of the user may be added directly to the user's contact record, or added to another data record which is linked to the user's contact record. The attributes and interests may be entered directly by the user through a suitable user interface, or automatically entered as a result of a data mining routine performed by the database and/or the social network.

In step 404, the social network monitors the attributes and interests that are stored in contact records in the database. In step 406, the social network creates a group on the basis of a single identifiable attribute or current interest of the user. In one embodiment, the attribute or interest selected by the social network as a basis for a virtual group is selected based upon defined criteria. In step 408, the social network adds users to the virtual group.

### 5. ENHANCED PERSONALIZATION AND INTERACTION OF USER INTERFACE

The dynamic creation of a virtual group on the social network based on a current user interest allows the social network to encapsulate and present relevant content to users who share that interest. Also, it allows the social network to render the content with a personalized interface based on user tastes and preferences, including the look and feel of the content and how the user interacts with the content. For example, user interaction models may be configured based on preferences for culinary taste, sports interest or any other personal or cultural themes. This type of personalization can motivate a user to interact with the virtual group content in a more meaningful and engaging way. In addition, this allows the social network to learn about user preferences for possible future interactions in other applications or services.

In addition to content being viewed by the end user, they also interact and modify the nature of presentation of virtual group initial interface by browsing and interaction on content presented within. For example, themes can be generated by the social network or setup by an administrator. Themes themselves have user interface (UI) elements like icons, buttons, cursor, haptic or gesture devices and/or many other types of input interfaces. The initial interface for the virtual group will capture a theme based on the UI elements. Further, these UI elements will be mapped to an appropriate image. For example, the cursor could be rendered as a fork in an American culinary theme or like chopsticks in an Asian culinary theme.

As another example, culinary theme humor based rendering could be categorized into time-based intervals as breakfast, lunch and dinner with particular preference to American foods. Thus, the virtual group interface for an American culinary theme can be dynamically rendered based on the time of user interaction with the social network. Customization of the virtual group interface is optional and a user can elect or default to a system-defined interface theme. These system-defined themes could be generic enough to capture virtual chatter group instances like most popular set of social media feeds due to influencers whose author content is relevant to the user's interest.

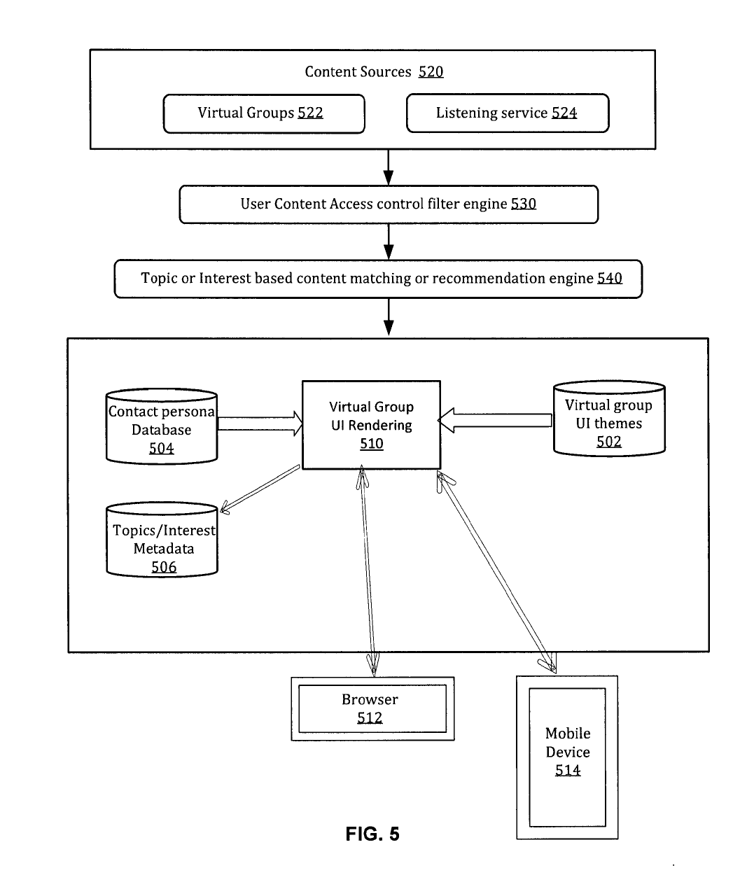

FIG. 5 illustrates the components of the user interface and the rendering of content from various sources. For example, database 502 stores virtual group UI themes; database 504 stores contact personas; and database 506 stores topics and interest metadata. Databases 502, 504, 506 may be a single integrated database or multiple individual databases resident on one or more servers. A UI rendering engine 510 or processor accesses all relevant information available to it and renders the user interface for virtual groups in accord with user-expressed preferences or system-inferred themes to a browser-based device 512 or other mobile display device 514.

A variety of content sources 520 can provide content to the UI rendering engine 510. For example, other groups 522 in the social network can provide feeds, posts, links, etc. that represent a user's interest in topics or entities to the UI rendering engine 510. A monitoring service 524, such as the Radian6 listening service provided by salesforce.com, of San Francisco, Calif., provides input that can be used to infer users' current interest in various topics or entities.

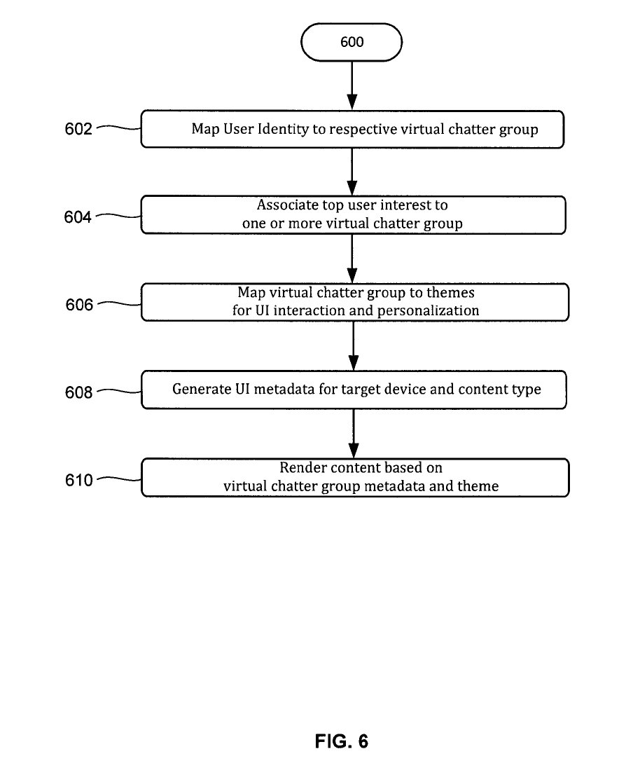

Referring to FIG. 6, a flow chart of a process 600 for rendering the user interface for a virtual group is illustrated. In step 602, user identities are mapped to respective virtual groups. In step 604, through monitoring personal profiles, the social network associates the top user interests to one or more virtual groups. In step 606, the virtual groups are mapped to themes for user interface interaction and personalization. In step 608, the social network generates user interface metadata for the target device and the content type. Finally, in step 610, content is rendered to the user device based on the virtual group metadata and themes.

### 6. VIRTUAL GROUP COLLABORATION AND USABILITY

In one embodiment, the UI rendering for a virtual group can include a collaboration section in which the virtual groups provide a summary of tags and feeds, or a static pinning-based interface. This enables drag and drop capability to render efficiently in the mobile interface. This capability allows user to perform operations on a browser based-chatter interface for customizing the look and feel and interaction of the interface for a mobile device.

User interaction with content can facilitate guided as well ad hoc user to user collaboration. Collaboration and user interaction with content is facilitated within virtual group themes having the UI interface elements discussed previously. Collaboration software agents can also act as a guide to facilitate collaboration with end users. These types of interaction are particularly suitable in fault detection and the service industry. In person-to-person or person-to-automated agent interactions, the UI interface elements will be appropriately mapped to user selection or preference. To improve the interface usability and user experience with virtual groups, evolving technologies like object tracking, internet of things and augmented reality visual technology can be incorporated based on the availability of these technologies. Incorporation of these technologies bridges and enhances the near real-time augmented reality experience of using physical objects within a targeted workspace or casual environment of social network content.

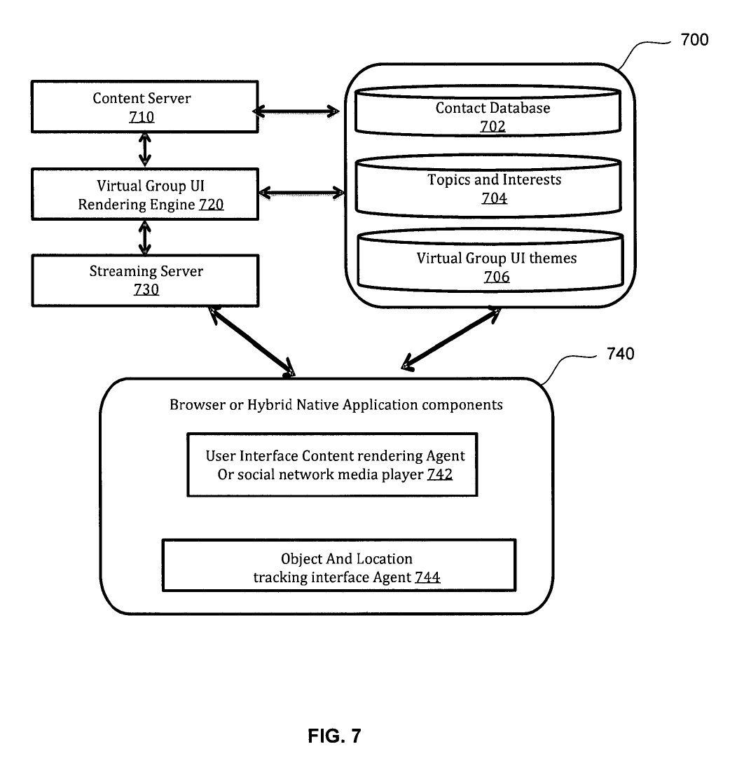

FIG. 7 illustrates system components for two-way collaboration and incorporation of evolving technologies, and for simplicity assumes static content. Further, collaboration features for dynamic rendering of physical objects can be extended to other contents like video and gaming etc.

An accessible database 700 includes database 702 for contact records, database 704 for topic and interest metadata, and database 706 for virtual group UI themes. Content server 710 interacts with the database 700 and the rendering engine 720. The rendering engine 720 also interacts with a streaming server 730 and the database 700. Finally, the streaming server 730 and the database 700 interact with a browser or other native application display components 740 to render content through the rendering agent 742. Advanced features such as object tracking and location tracking can be included in an interface agent 744.

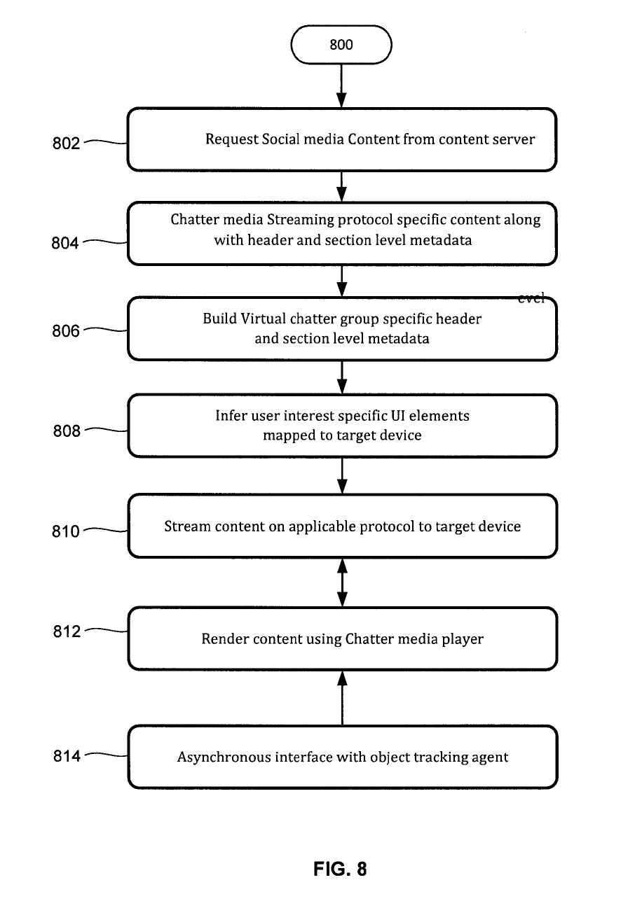

FIG. 8 is a flow chart of user interaction in the collaborative space of a virtual group. In step 802, social media content is requested by a user from the content server. In step 804, the streaming protocol is identified along with a header and section level metadata. In Step 806, a virtual group is created by the social network using the group specific header and section level metadata. In step 808, the UI elements that are specific to the user interest are mapped to the target device.

In step 810, the requested content is streamed to the target device using the applicable protocol. In step 812, the requested content is rendered using the media player of the social network. In step 814, object tracking is used in an asynchronous interface. The media player is a client-side component with asynchronous messaging capability for two-way content exchange as well as required compute logic for embedding the images of objects being tracked as part of interest specific user interaction experience.

### 7. VIRTUAL GROUP FOR SEARCH AND RECOMMENDATION

A current recommendation for products and services is typically based on user or item recommender systems. A expert user may provide ratings and item recommendations, which are transformed into a pre-computed static data for varying use cases. This pre-computed recommendation data is often based on the expert user's perception or judgment and preference at the moment of interaction with the product or service. However, this approach often leads to a disconnect between the intended recommendation of an expert user with the actual product experience of a non-expert user.

The provision of a collaborative workspace in a virtual group is enhanced to support a recommendation platform and user interface so as to facilitate the natural user experience during a complete lifecycle of product ownership. This approach bridges some of limitations of current machine learning based recommender system. The objective is to provide a platform for a product reviewer or relevant business personnel to provide a recommendation in near real time. This form of peer-to-peer or peer-to-many near real time recommendation provides an opportunity for a recommender to fine tune or personalize the user interaction experience. A recommendation for multimedia content in a virtual group interface by itself could either be helpful supplemental material for a product or service purchased by a user, or it could be a service like healthcare therapy. For example, motion sickness is primarily due to problem with the patient's vestibular system resulting in poor coordination between visual input and motion sensors in the inner ear. Some effective therapy techniques for this problem are based on multimedia content with varying degrees of involvement between the patient and the therapist. Adaptive display is a component of virtual group collaboration environment and complete system provides near real time visibility to therapy process.

Too often, recommendations for products and services do not meet user needs due to either lack of complete visibility of product usage constraints, or as a result of first time usage by the user. Thus, the ability to capture user feedback about satisfaction during usage may also be integrated in the virtual group. For example, the capture of a simple and yet intuitive gesture, like a thumbs up indicator or audio confirmation, facilitate a natural user experience for the feedback process.

Thus, in one embodiment, a recommendation platform takes into consideration individual ratings of product and services and computes an aggregate score. The aggregate score is a multi-field encoded value where each field represents a rating for a sub-component, product, service, etc. The use of an aggregate representation to support a recommendation is important for capturing the notion of a product life-cycle ownership-based recommendation. Providing a recommendation score of this type in near real time is analogous to a ticker symbol in stock trading domain. The user interface and back end components for a recommendation system can provide current and historical views of recommendation data from product users along with any significant events or news related to that product and service. Such data provides users with the ability to subscribe to triggers which can be configured in a customized way for various categories of product or service domain related features, including usability, defects, count of other end users, or any other defined product or service features.

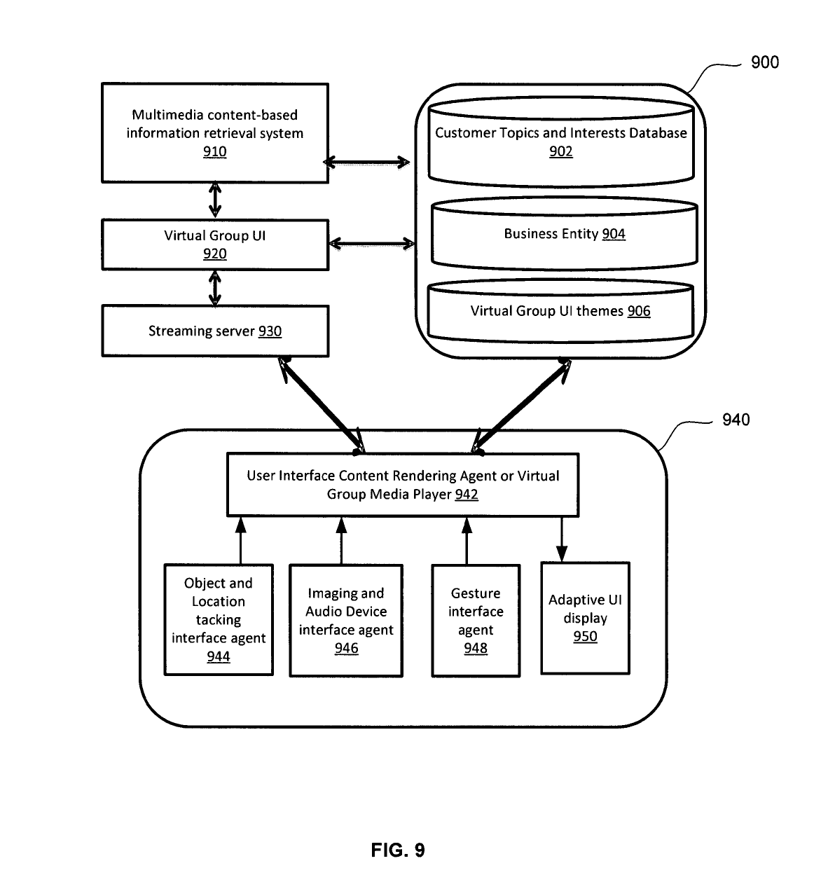

FIG. 9 illustrates the components for a collaborative recommendation environment. The accessible database 900 includes database 902 for contact records, database 904 for business entity products and services, and database 906 for virtual group UI themes. A multimedia content retrieval system 910 interacts with the database 900 and the virtual group UI 920. The virtual group UI 920 also interacts with a streaming server 930 and the database 900. Finally, the streaming server 930 and the database 900 interact to render content with a rendering agent or media player 942. Advanced features such as object tracking and location tracking can be included in an interface agent 944. Other interface agents are also provided, including interface agent 946 for imaging and audio devices; interface agent 948 for capture of user gestures; and interface agent 950 for an adaptive UI display.

In certain customer environment contexts, the media player device capabilities, such as voice recognition and speech synthesis, will be integrated to capture feedback or workflow confirmations.

In this configuration, the user of a virtual group is rendered a visual representation of a product with appropriate annotated and segmented content of the product along with an appropriate palette of toolkit images. These toolkit images are mapped to the equivalent recommended physical objects along with respective multimedia content as assistive help. A user's current interest in topics and entities could further customize the toolkit content and recommendation engine.

This platform also enables real-time recommendations by existing product owners or experts with the ability to interact on multiple devices including mobile devices. These interactions between a current product customer and new users provide valuable social and product insights to a product developer. Also, it allows product developers to promote newer social engagement titles and marketing opportunities to obtain valuable feedback on future planned products.

To facilitate a natural user experience, enhanced image-based search capabilities are integrated with the virtual group in order to validate recommended tools. These capabilities are built on content-based image retrieval techniques for appropriate image segments and associated tools. In certain service scenarios, these capabilities could correspond to problem resolution workflow steps, for example, the front or back panel of a television being serviced for connectivity issues.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

1. A method for dynamic generation of groups for a social network, wherein an individual is connected to a plurality of other individuals by the social network, comprising:
storing a plurality of contact records in a database, each contact record representing a user of the social network individual and having a plurality of data fields, a selected one of the data fields having information about current interests of the individual in topics or entities;
monitoring the selected data field of a plurality contact records;
automatically creating a virtual group with the social network for at least one current interest described in the selected data field of a plurality of contact records based on criteria for selecting the current interest; and
automatically adding, by the social network, a plurality of individuals to the created virtual group, the added individuals having the one current interest in the selected data field of the corresponding contact record.

2. The method of claim 1, further comprising:
inferring the current interests of the individual by monitoring interactions of the individual with the social network.

3. The method of claim 1, further comprising:
inferring the current interests of the individual by evaluating information in the selected data field.

4. The method of claim 1, further comprising:
delivering related content and feeds to individuals that are added to the virtual group.

5. The method of claim 4, further comprising:
setting an expiration time on delivered content.

6. The method of claim 1, further comprising:
dynamically creating and deleting virtual groups based on current user interests in topics or entities.

7. The method of claim 1, wherein the monitoring step is performed periodically.

8. The method of claim 1, further comprising:
identifying relevant information feeds for the created virtual group; and
subscribing the virtual group to at least one of the relevant information feeds.

9. The method of claim 1, further comprising:
identifying entities that are relevant for the created virtual group; and
configuring the virtual group to follow at least one of the relevant entities.

10. The method of claim 4, further comprising:
personalizing a user interface that is rendered to an individual that has been added to the virtual group based on a theme selected for the virtual group.

11. A non-transitory computer-readable storage medium encoded with executable instructions for dynamic generation of groups for a social network, wherein an individual is connected to a plurality of other individuals by the social network, and wherein execution of the instructions by a processor cause the processor to carry out the steps of:
storing a plurality of contact records in a database, each contact record representing a user of the social network individual and having a plurality of data fields, a selected one of the data fields having information about current interests of the individual in topics or entities;
monitoring the selected data field of a plurality contact records;
automatically creating a group with the social network for at least one current interest described in the selected data field of a plurality of contact records based on criteria for selecting the current interest; and
automatically adding, by the social network, a plurality of individuals to the created group, the added individuals having the one current interest in the selected data field of the corresponding contact record.

12. The computer-readable medium of claim 11, the instructions further comprising:
inferring the current interests of the individual.

13. The computer-readable medium of claim 11, the instructions further comprising:
delivering related content and feeds to individuals that are added to the virtual group.

14. The computer-readable medium of claim 11, the instructions further comprising:
dynamically creating and deleting virtual groups based on current user interests in topics or entities.

15. The computer-readable medium of claim 11, the instructions further comprising:
identifying relevant information feeds for the created virtual group; and
subscribing the virtual group to at least one of the relevant information feeds.

16. The computer-readable medium of claim 11, the instructions further comprising:
identifying entities that are relevant for the created virtual group; and
configuring the virtual group to follow at least one of the relevant entities.

17. The computer-readable medium of claim 13, further comprising:
personalizing a user interface that is rendered to an individual that has been added to the virtual group based on a theme selected for the virtual group.

18. A system for dynamic generation of groups for a social network, wherein an individual is connected to a plurality of other individuals by the social network, comprising:
a processor; and
one or more stored sequences of instructions which, when executed by the processor, cause the processor to carry out the steps of:
storing a plurality of contact records in a database, each contact record representing a user of the social network individual and having a plurality of data fields, a selected one of the data fields having information about current interests of the individual in topics or entities;
monitoring the selected data field of a plurality contact records;
automatically creating a group with the social network for at least one current interest described in the selected data field of a plurality of contact records based on criteria for selecting the current interest; and
automatically adding, by the social network, a plurality of individuals to the created group, the added individuals having the one current interest in the selected data field of the corresponding contact record.

19. The system of claim 18, wherein the steps executed by the processor further comprise:
delivering related content and feeds to individuals that are added to the virtual group.

20. The system of claim 18, wherein the steps executed by the processor further comprise:
creating and deleting virtual groups dynamically based on current user interests in topics or entities.
